(19) United States
(12) Patent Application Publication
(10) Pub. No.: US 2022/0252251 A1
(43) Pub. Date: Aug. 11, 2022

(54) Socket Cam

(71) Applicant: Kevin Vernon, Hamilton (CA)

(72) Inventor: Kevin Vernon, Hamilton (CA)

(21) Appl. No.: 17/304,668

(22) Filed: Jun. 24, 2021

(30) Foreign Application Priority Data
Feb. 10, 2021 (CA) 3108490

(51) Int. Cl. F21V 33/00; F21V 23/04; H04N 5/225; H04N 5/232

(52) U.S. Cl. CPC F21V 33/0052; F21V 23/04; F21Y 2115/10; H04N 5/23299; H04N 5/23203; H04N 5/2257

(57) ABSTRACT

The Socket Camera is a device the will provide motion detection/tracking, audio/video surveillance and recording. Outside of the house for security purposes and inside the house for monitoring children and daily activities. It will also provide an LED light source to illuminate a given area. It will interface will a personal device via Wi-Fi or Bluetooth in order to save recordings and change settings. The personal device will also control functions of the Socket Camera. The Socket Camera will be powered and electrified the same way as a common light bulb. It will be screwed into a fixture socket and locked in place with a tool at its collar so that it can not be removed without the proper tool.

### SPECIFICATIONS DRAWING DESCRIPTIONS

FIG. 1 depicts the socket camera fully assembled as a functioning unit Here after pertaining to this document the socket camera may also be referred to as device or invention. The camera lens (indicated as 7, in FIG. 1 and FIG. 2) on this unit/drawing is located at a 90 degree angle of viewing from the device for most perpendicular installations of the device and some overhead installations of the device. This device shall be easily installed in any standard light bulb socket Edison screw.

FIG. 2 depicts the socket camera fully assembled as a functioning unit. Here after pertaining to this document the socket camera may also be referred to as device or invention. The camera lens (indicated as 1, in FIG. 1 and FIG. 2) on this unit/drawing is on the top of this unit at a 180 degree angle of viewing from the device for some overhead and floodlight applications and installations of the device. This device shall be easily installed in any standard light bulb socket Edison screw.

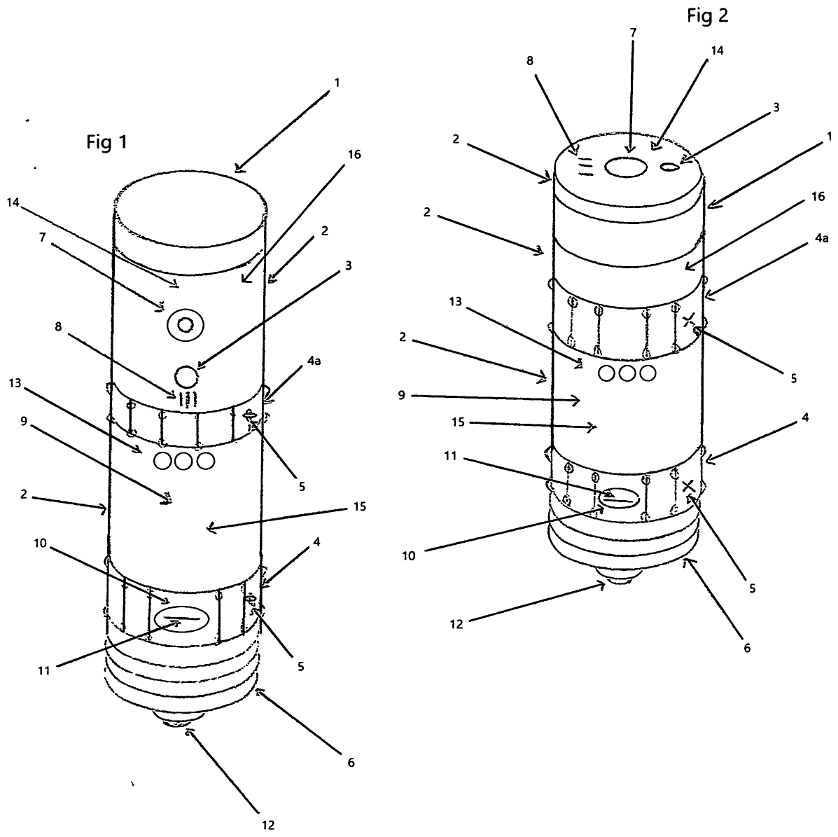

As indicated on the diagrams as 1 (in FIGS. 1 and 2) is an LED lighting unit or segment. This LED light shall provide adequate lighting for the surroundings of the location in which the socket camera is installed. This LED light will have a selection of colours to be chosen from the APP on a personal device which controls the functions of the socket camera.

As indicated on the diagrams as 2 (in FIGS. 1 and 2) is the housing or body of the socket camera. The water resistant housing will contain and protect the inner circuitry and mechanisms that allow the socket camera to function.

As indicated on the diagrams as 3 (in FIGS. 1 and 2) is the motion detector. When the motion detector is activated it will enable the motor and motion tracking features of the socket camera. When motion is no longer detected the camera will return to the initial position that it was set to. The motion detector will activate the lighting if this feature is selected. The motion detector will also activate music when motion is detected in range of the device if this feature is selected.

As indicated on the diagrams as 4 and 4A (in FIGS. 1 and 2) is the rotating locking collar on the device. This is a security feature to prevent theft and tampering of the socket camera. A specific key/tool will be fashioned to insert into a moulded recess that only this key/tool will fit locking or unlocking this rotating collar permitting the removal of this device once installed. If this key/tool is not used the collar will keep spinning and not engage the device preventing the removal of the socket camera once installed. The rotating collar indicated as 4A and the upper segment of this device will be motorized permitting the feature of motion tracking and control of the device to move ubiquitously with pan and tilt.

As indicated on the diagrams as 5 (in FIG. 1 and FIG. 2) will be the key/tool hole or moulded recess to allow the insertion of a crafted tool that will engage or disengage the locking and unlocking of the rotating locking collar.

As indicated on the diagrams as 6 (in FIG. 1 and FIG. 2) is the standard light bulb Edison screw threading. This will enable any user to install the socket camera into any light bulb socket that accepts this size threading.

As indicated in the diagrams as 7 (in FIG. 1 and FIG. 2) is the camera lens. This will be a wide angle camera lens to capture as much visible video image as possible. This camera lens will be of the type to capture video images in very low light levels and conditions. This camera lens will be of the type to capture images in the infra red spectrum. If your monitoring device is such as a computer, laptop, game console, tablet or phone and has an enabled VR HEADSET you will be able to view footage from the Socket camera in real time and manoeuvre the Socket camera in real time by donning the VR headset. The sensors in the VR headset can detect when the user turns their head left, right, up or down and will relay the coding data to the Socket camera to perform the functions of panning and tilting accordingly in real time. The Socket camera will capture footage at 130 fps and playback at 30 fps drop frame for smooth motion capture and to minimize lag. Additionally you shall be able to don a VR headset and using a handheld device, joystick or remote control device; control the Socket camera to perform the functions of pan, tilt and zoom. Using the hand held device you can switch and select through multiple Socket cameras that are on the network. Switch modes from night vision, regular capture and infrared capture or any other feature provided by the Socket camera for viewing in real time in the VR headset. The Socket camera will also perform the function of a 360 degree VR camera. The Socket camera on command will rotate 360 degrees and video capture its surroundings from many different view points while panning and tilting then render the capture for viewing in virtual reality on a VR headset or monitor device. As indicated in the diagrams as 8 (in FIG. 1 and FIG. 2) is a microphone. This is a two-way microphone. This microphone will detect, transmit and permit recording of any sounds in the vicinity of the socket camera. This microphone will also relay and transmit any speech or sounds by the user of the socket camera via the control APP interface on a personal device via WIFI or Bluetooth.

As indicated on the diagrams as 9 (in FIG. 1 and FIG. 2) is an internal rechargeable battery. The socket camera will be able to operate and function from the electrical power that is stored in this internal battery. The two ways in which the socket camera will obtain power for operation to perform its functions will be by; (1) power that is delivered to the device from being installed in a light bulb socket and delivered by branch circuitry from a building structure, vehicle or generator. Or (2) from the internal rechargeable battery. When the socket camera is not running on it's internal battery the battery will be rechargeable when power is being delivered from being installed in a light bulb socket. The APP that controls the socket camera will allow the user to control if the rechargeable battery is to be recharged or not. After the internal battery has been recharged to full it will trickle charge so as not to continue to over charge the battery. This will allow the internal battery to have a extended user life.

As indicated in the diagram as 10 (in FIG. 1 and FIG. 2) is an open hole access in the rotating collar to allow access to the SD mini slot (11)

As indicated in the diagram as 11 (in FIG. 1 and FIG. 2) is an open access slot for an SD mini removable drive. The User will be able to insert a memory card of varying ram size to record audio and video that is captured by the socket camera and play the footage on a external device.

As indicated in the diagram as 12 (in FIG. 1 and FIG. 2) is the power contact that is common to all Edison screw standard sized light bulbs.

As indicated in the diagram as 13 (in FIG. 1 and FIG. 2) are full range speakers. These speakers will transmit sounds in lower, mid range and high range frequencies. 3 dedicated speakers. One for low range, one for high range and one for mid range. The LIGHTBULB SPEAKERS of the Socket camera can also stream music and audio over a WIFI network, WIFI direct or Bluetooth. The user will be able to assign the LIGHTBULB SPEAKERS of the Socket camera as programmable surround sound speakers for your TV, game console computer or personal device. The light bulb speakers within the Socket camera can be assigned as left, right, front, centre or rear surround sound speakers over a WIFI network or Bluetooth. The socket camera light bulb speakers volume can be controlled by the source device or phone APP WITH or WITHOUT an active camera over WIFI or Bluetooth.

As indicated in the diagram as 14 (in FIG. 1 and FIG. 2) is a thermo hygrometer. This device will read and capture then transmit the relative humidity and temperature of the ambient atmosphere in which the device is located. The user will be able to access this information on the APP that interfaces and controls the socket camera. As indicated in the diagram as 15 (in FIG. 1 and FIG. 2) will be located a drive for internal storage. The internal storage will be used in place of the SI) mini slot to enable this device to be water resistant.

As indicated in the diagram as 16 (in FIG. 1 and FIG. 2) will be an antennae that will provide the function of WiFi, WiFi hot spot and WiFi signal booster. If the socket camera is installed outside of the building structure or at an extremity of a building structure the socket camera will also be able to enable the feature of a WiFi hot spot. This will allow the user to use personal devices connecting to the WiFi of the building structure via the socket camera instead of using data on a data plan provided by a personal device. The socket camera will also provide the function of a Wifi signal booster. If there are other devices or socket cameras that are further away from the building structure out of range from the WiFi provided by the building structure they will be able to connect to the WiFi signal of the socket camera that is closest.

We claim—that the attributes of the socket camera shall be that:

1. The Socket Camera will be a cylindrical, spheroid, sphere shaped device or any combination thereof that will perform the function of audio/video surveillance and recording. The Socket Camera will provide LED lighting. Have a camera and microphone. Have two way speaker(s) system full range sound. A motion detector. A CPU. The Socket Camera will be powered via electrification. This device will be screwed into a socket as a common light bulb would be to attain power. After the device is screwed into a light socket it will have a rotating collar that must be locked and unlocked by a specific tool/key. The Socket Camera will not be removable from the socket unless the specific tool/key locks the collar in place so that the device can be unscrewed from the power socket. If the tool/key is not correctly used the collar will keep spinning not allowing the Socket camera to be unscrewed from the socket. The upper segment and ring will be motorized and can be controlled by the App to point the camera in the desired ubiquitous direction using pan and tilt. The camera will also maneuver via motion tracking ubiquitously using pan and tilt. The device will not be removable or unscrewed from the top of the device if the tool/key is not engaged the device will keep spinning. This Socket camera will have a built in rechargeable battery. This battery will recharge when the light switch is placed in the on position and the device in running on AC (household) power. When the light switch is in the off position the camera, motion detector and microphone will be powered by the rechargeable battery. This device will have a camera and microphone to record video and audio. The camera will have a rotating collar such as the one that locks the device into the socket. A specific tool/key will be needed to turn the camera to a given direction. The camera direction will be locked in place by the collar and tool/key so that the direction of the camera cannot be changed unless the tool/key is used to unlock the collar to allow rotation. The camera will either be midway up the device at a 90 degree angle of view. Or at the top of the cylinder of the device at a 180 degree angle for a downward view or upward view from the device. The Socket camera will have a port for an SD mini memory card. Any recorded information will be stored on this card for playback on a supported device. The water resistant model will have internal storage. The SD card will have loop recording capabilities. The model of the Socket camera that has the camera midway up the device. Facing 90 degrees the LED lighting system will be at the top or end of the device. The model of the Socket camera that has the camera at the top or end of the device where the camera is facing at 180 degrees. The LED lighting will be midway through the device. The LED lighting for both models of the Socket camera will be an Omni directional lighting segment or unit. The Socket camera will have a toggle switch or button to turn off or on the LED lights when the device is being powered. The Socket camera will be equipped with night vision, infra red and low light camera technology.

2. The Socket camera will have Wi-Fi and Bluetooth connectivity to a personal device to control the functions of the camera and features from the App. An APP on a personal device will control the functions, features, lights and manage the recordings of the Socket camera. Any personal device will also be capable of retaining and play back of recorded information. Some features of the Socket camera will be temperature and hygrometer readings at device location. Wi-Fi hot spot. Music player. You can play and stream music via blue tooth. The device will have facial recognition so if an incident occurs you will be able to search a database. You can share recordings via email. You can post your recordings to social media. The device is portable so you may use it in hotel rooms, offices and vacation properties. One account will have global use if you connect to WiFi. The App will enable control of multiple cameras. The App and device will update with newer features. The Socket camera will have cloud storage that will interface via an APP on any personal device. The Socket camera will be a hybrid of a fully functioning light (bulb) source and a audio/video surveillance device.
